(19) United States
(12) Patent Application Publication
(10) Pub. No.: US 2025/0229953 A1
(43) Pub. Date: Jul. 17, 2025

(54) MULTI-COMPARTMENT CONTAINER

(71) Applicant: Anhui E-link plastic industry Co., LTD, Chuzhou City (CN)

(72) Inventor: You Lin Wang, New Taipei City (TW)

(73) Assignee: Anhui E-link plastic industry Co., LTD, Chuzhou City (CN)

(21) Appl. No.: 18/413,249

(22) Filed: Jan. 16, 2024

(51) Int. Cl. B65D 43/22; B65D 25/04; B65D 25/20; B65D 43/02; B65D 43/16; B65D 81/26

(52) U.S. Cl. CPC B65D 43/22; B65D 25/04; B65D 25/20; B65D 43/0202; B65D 43/163; B65D 81/266; B65D 2543/00231

(57) ABSTRACT

A multi-compartment container has a main body, an upper cover, a lower cover, and a base. The base is mounted on a bottom side of the main body. The lower cover is mounted on a top of the main body. The upper cover is rotatably mounted on a top of the lower cover. The main body has multiple compartments symmetrically surrounding a central axis. The lower cover has a central board and multiple flip covers. The flip covers are disposed along edges of the central board, and a location of each one of the flip covers corresponds to a respective one of the compartments of the main body. The upper cover has a flipping notch which corresponds to one of the flip covers, thereby flipping up the flip cover. The multi-compartment container is capable of storing different medications.

### BACKGROUND

### 1. Field of the Invention

The present invention relates to a multi-compartment container, especially to a multi-compartment container that is capable of storing various medications.

### 2. Description of the Prior Arts

In recent years, with improvement of living standards and health awareness, people tend to have more medications or health supplements, and thus it is necessary to adopt a container for storing pills or capsules. When several different medications are stored in a conventional pill container, it would be difficult to distinguish one from another since the conventional pill container is not partitioned, and thus it is hard to pick up the needed medication from a mixture. Moreover, some medications are not allowed to be stored and mixed together. Therefore, the conventional pill container is only capable of storing one medication, and thus the user has to use a plurality of pill containers for storing different medications, occupying too much space and resulting in inconvenience.

To overcome the shortcomings, the present invention provides a multi-compartment container to mitigate or obviate the aforementioned problems.

### SUMMARY

The main objective of the present invention is to provide a multi-compartment container that solves the issues that a conventional pill container is incapable of storing different medications, and thus a plurality of pill containers is needed for storing different medications, occupying too much space.

The multi-compartment container has a main body, a base, a lower cover, and an upper cover. The main body has multiple compartments, the compartments symmetrically surrounds a central axis of the main body. The base is mounted at a bottom side of the main body. The lower cover is mounted on a top of the main body, the lower cover has a central board and multiple flip covers, and the flip covers are disposed along edges of the central board. A location of each one of the flip covers corresponds to a respective one of the compartments of the main body. The upper cover is rotatably mounted on a top of the lower cover. The upper cover has a flipping notch, the flipping notch is selectively aligned with one of the flip covers, thereby flipping up said one of the flip covers.

The multi-compartment container has multiple compartments, and thereby the user can store different kinds of medications without mixing them. The flip covers respectively correspond to the compartments, and thus each one of the flip covers is capable of opening or closing the corresponding compartment. The user can rotate the upper cover with respect to the lower cover to turn the flipping notch to a particular compartment, thereby flipping up the corresponding flip cover, and then the user can take out the medications from the compartment.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a multi-compartment container in accordance with the present invention;

FIG. 2 is an exploded view of the multi-compartment container in FIG. 1;

FIG. 3 is a back view of the multi-compartment container in FIG. 1;

FIG. 4 is a cross-sectional view of the multi-compartment container in FIG. 1;

FIG. 5 is a perspective view of a main body in FIG. 1;

FIG. 6 is another perspective view of the main body in FIG. 5;

FIG. 7 is a perspective view of an upper cover in FIG. 1, showing a bottom side of the upper cover;

FIG. 8 is a top view of the upper cover in FIG. 7;

FIG. 9 is a bottom view of a lower cover in FIG. 1;

FIG. 10 is a partial cross-sectional view of the lower cover in FIG. 9, showing a flip cover flipped up and an elastic unit mounted on the flip cover;

FIG. 11 is a perspective view of a second embodiment of the multi-compartment container;

FIG. 12 is a cross-sectional side view of the multi-compartment container in FIG. 11; and

FIG. 13 is a perspective view of a third embodiment of the multi-compartment container.

### DETAILED DESCRIPTION

The main objective of the present invention is to provide a multi-compartment container that solves the issues that a conventional pill container is only capable of storing one medication, and thus a plurality of pill containers is needed for storing different medications, occupying too much space.

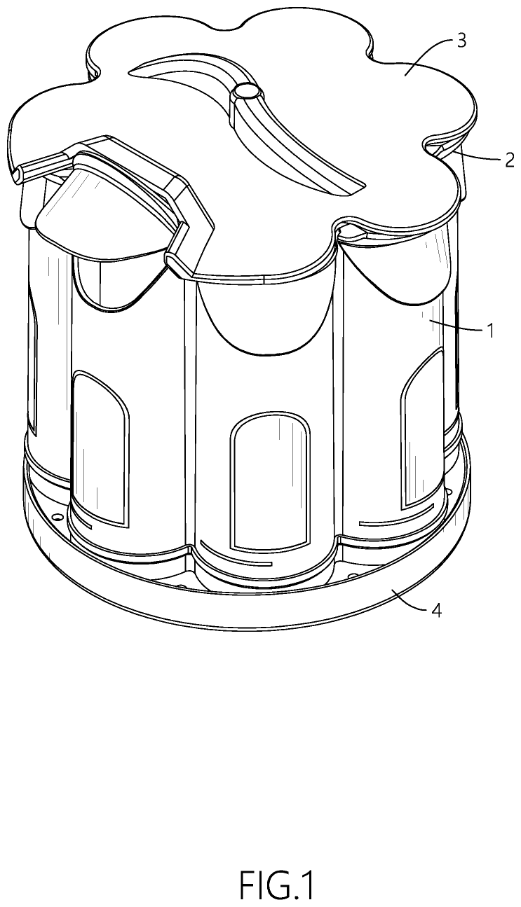

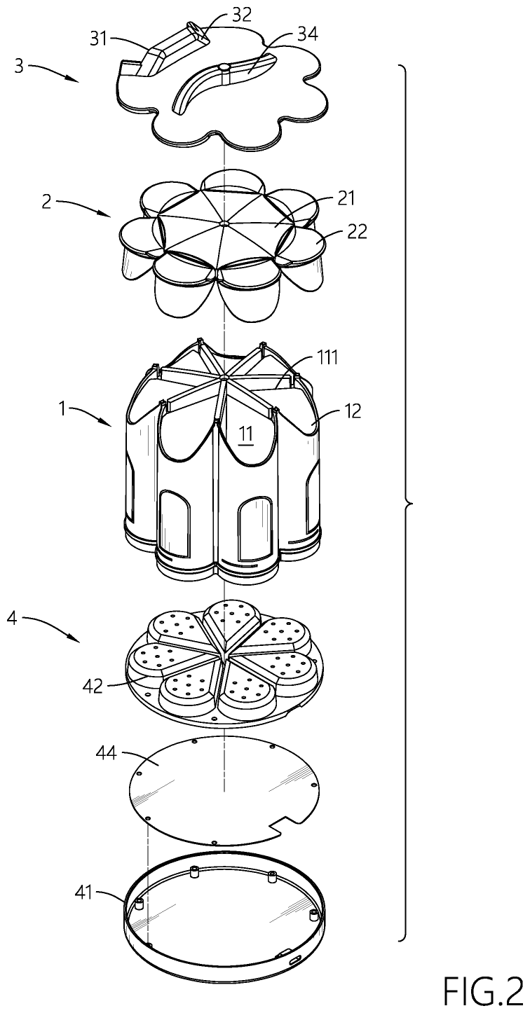

With reference to FIGS. 1 and 2, a first embodiment of the multi-compartment container has a main body 1, a lower cover 2, an upper cover 3, and a base 4. The base 4 is mounted at a bottom side of the main body 1, the lower cover 2 is mounted on a top of the main body 1, and the upper cover 3 is rotatably mounted on a top of the lower cover 2.

With reference to FIGS. 1 to 4, the main body 1 has multiple compartments 11, and the compartments 11 symmetrically surround a central axis of the main body 1. The lower cover 2 has a central board 21 and multiple flip covers 22, and the flip covers 22 are disposed along edges of the central board 21; a location of each one of the flip covers 22 corresponds to a respective one of the compartments 11 of the main body 1. The upper cover 3 has a flipping notch 31, and the flipping notch 31 is selectively aligned with one of the flip covers 22, thereby flipping up said flip cover 22.

The base 4, mounted on the bottom side of the main body 1, is capable of supporting the main body 1, and in order to put medications into the multi-compartment container, a user may remove the base 4 from the main body 1, place the medications at the locations on the base 4 that correspond to the compartments 11 of the main body 1, and then reconnect the main body 1 and the base 4, but it is not limited thereto, as the user can flip up the flip covers 22 to put the medications into the compartments 11.

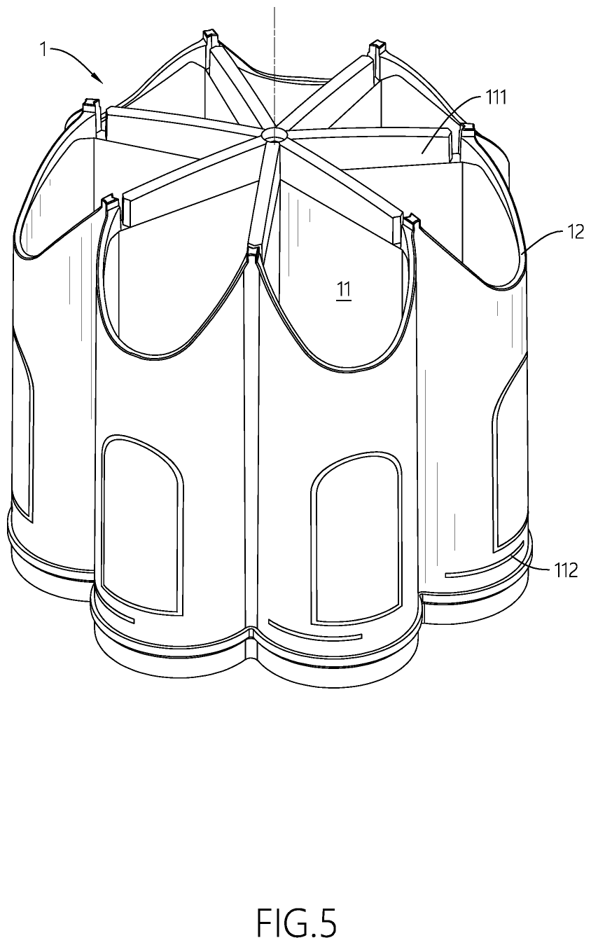

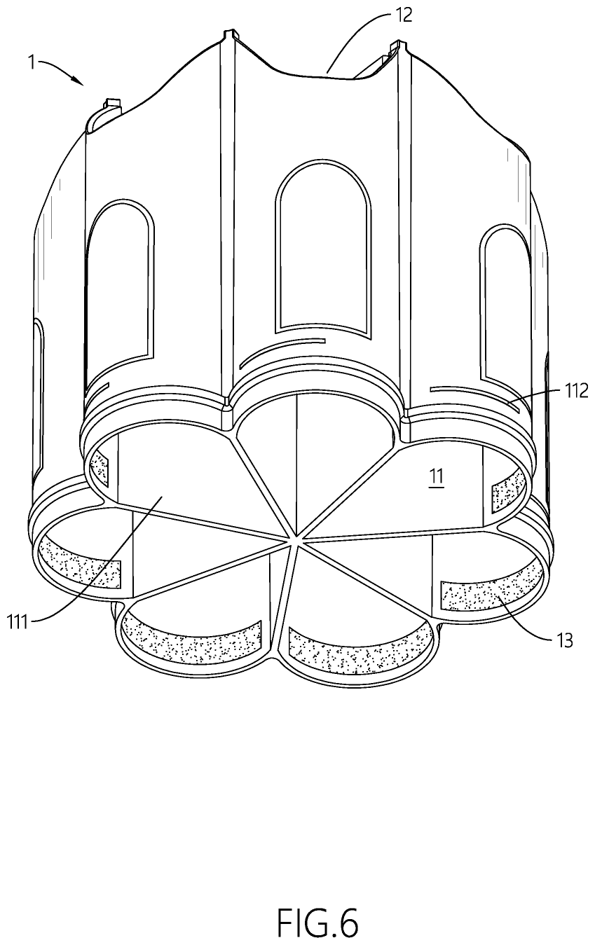

With reference to FIGS. 5 and 6 together, the main body 1 has the multiple compartments 11 which symmetrically surround the central axis of the main body 1, so medications of different kinds can be stored separately instead of being mixed, which is easy for the user to pick up the medications needed. The lower cover 2 is mounted on the top of the main body 1, and each one of the flip covers 22 corresponds to a respective one of the compartments 11 of the main body 1, and thereby each one of the flip covers 22 is capable of opening or closing the corresponding compartment 11 of the main body 1.

The upper cover 3 is capable of abutting and pressing the flip covers 22 because the upper cover 3 is rotatably mounted on the top of the lower cover 2 and covers the lower cover 2. The location of the flipping notch 31 of the upper cover 3 corresponds to one of the flip covers 22; to be more precise, the location of the flipping notch 31 is changed as long as the upper cover 3 rotates with respect to the lower cover 2, and when the flipping notch 31 is located above any one of the flip covers 22, said flip cover 22 can be flipped up to open the corresponding compartment 11 of the main body 1, and then the medications in said compartment 11 can be taken out.

An amount of the compartments 11 may be altered according to need; in this embodiment, the main body 1 has seven of the compartments 11, but it is not limited thereto. The main body 1 having the multiple compartments 11 would have a larger storage space, thereby being convenient to store and organize medications. The compartments 11 together surround the central axis of the main body 1, thereby shaped like a flower. Other components of the multi-compartment container may be adapted to the main body 1. A size of the flipping notch 31 is adapted to a size of each one of the flip covers 22, and thereby the flip covers 22 can be flipped up.

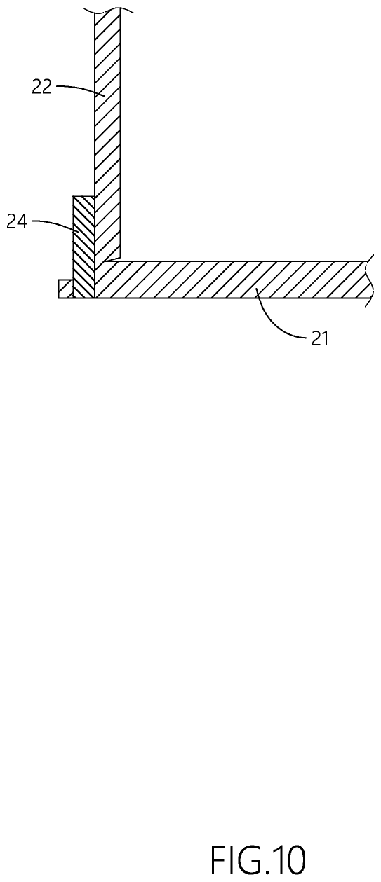

With reference to FIG. 10, each one of the flip covers 21 has an elastic unit 22 mounted on an inner side of the flip cover, and thereby when the flipping notch 31 is located above any one of the flip covers 22, said flip cover 22 would bounce up to open the compartment 11 instead of flipped manually, thus being more convenient to use. In this embodiment, as shown in FIG. 10, the elastic unit 24 is a piece of silicone installed at a site of the central board 21 to which the flip cover 21 is connected, but it is not limited thereto; in another embodiment, the elastic unit 24 may be a spring mounted between each one of the flip covers 22 and the central board 21.

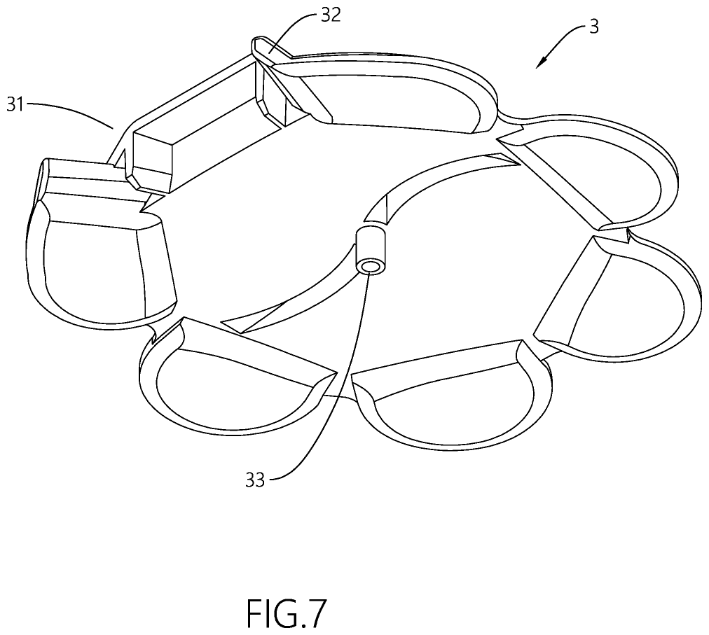

With reference to FIGS. 2, 7, and 8, the upper cover 3 has two oblique boards 32 located on two opposite sides of the flipping notch 31, and each one of the two oblique boards 32 is inclined inward and upward with respect to the flipping notch 31.

Under a condition that the elastic unit 24 is mounted on the inner side of each one of the flip covers 22, the oblique boards 32 respectively located on the two opposite sides of the flipping notch 31 are capable of decreasing the impact generated by the flip cover 22 bouncing, preventing the flip cover 22 from wearing.

With reference to FIGS. 2, 5, and 6, the main body 1 has multiple lateral notches 12 formed on a lateral wall of the main body 1. Locations of the lateral notches 12 respectively correspond to the compartments 11, and are adjacent to the lower cover 2. Each one of the flip covers 22 covers a corresponding one of the lateral notches 12. The lateral notch 12 helps to expand an opening of the compartment 11, thereby being more convenient for the user to pick up the medications.

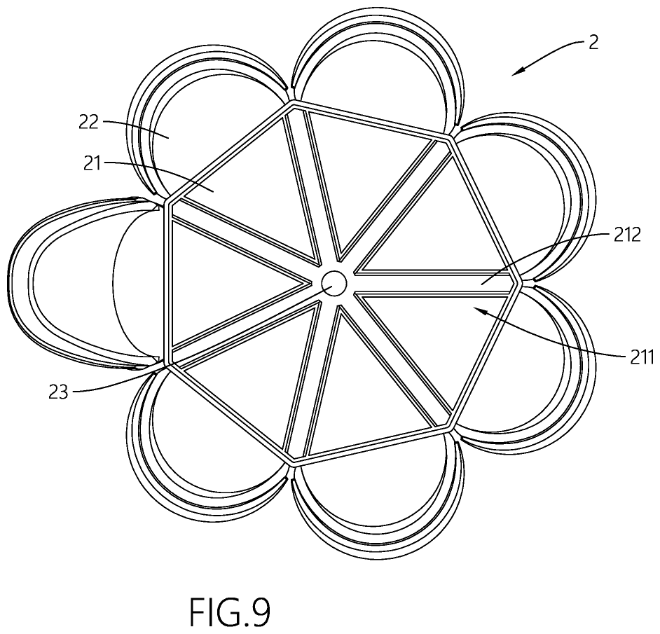

With reference to FIGS. 2, 5, and 9, the main body 1 has multiple partition walls 111, the lower cover 2 has multiple support frames 211, and each one of the partition walls 111 engages with a corresponding one of the support frames 211.

To be more precise, each one of the partition walls 111 is located between adjacent two of the compartments 11. The support frames 211 are mounted at a bottom side of the central board 21, and the support frames 211 surround a central axis of the lower cover 2 and are disposed symmetrically with respect to said central axis, thereby increasing a structural stability of the lower cover 2.

Each one of the support frames 211 has an engaging groove 212, and each one of the partition walls 111 engages with the engaging groove 212 of the corresponding one of the support frames 211. Therefore, the lower cover 2 and the main body 1 could be pressed to closely connect to each other, facilitating ease in installation and improving a moisture proof effect.

Furthermore, the main body 1 and the base 4 engage with each other to closely connect to each other, in addition to close connection of the main body 1 and the lower cover 2, effects of sealing and moisture proof get improved, and thereby a storage period of the medications in the compartments 11 may be prolonged.

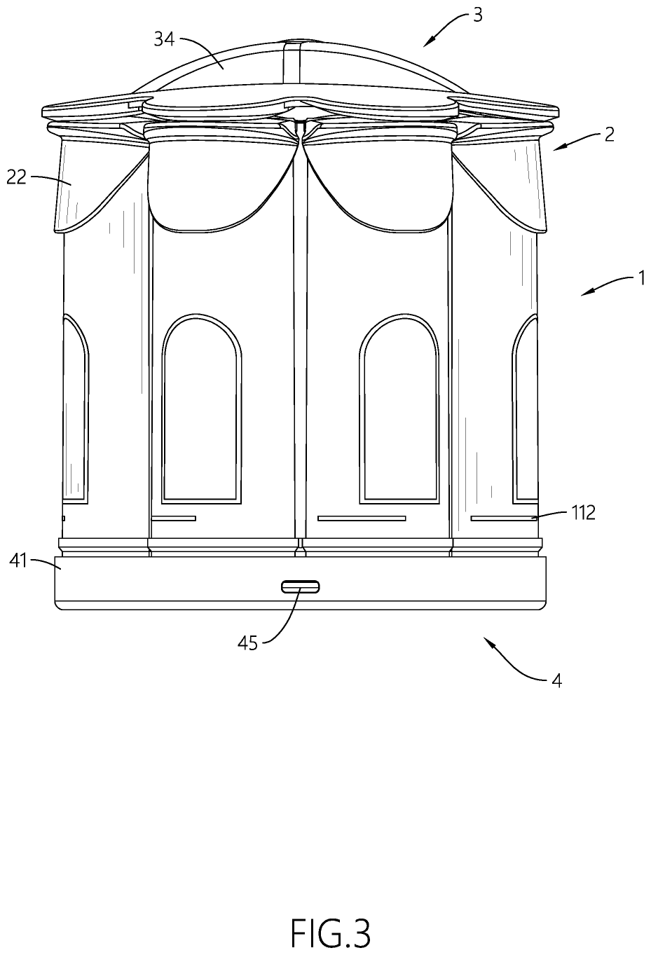

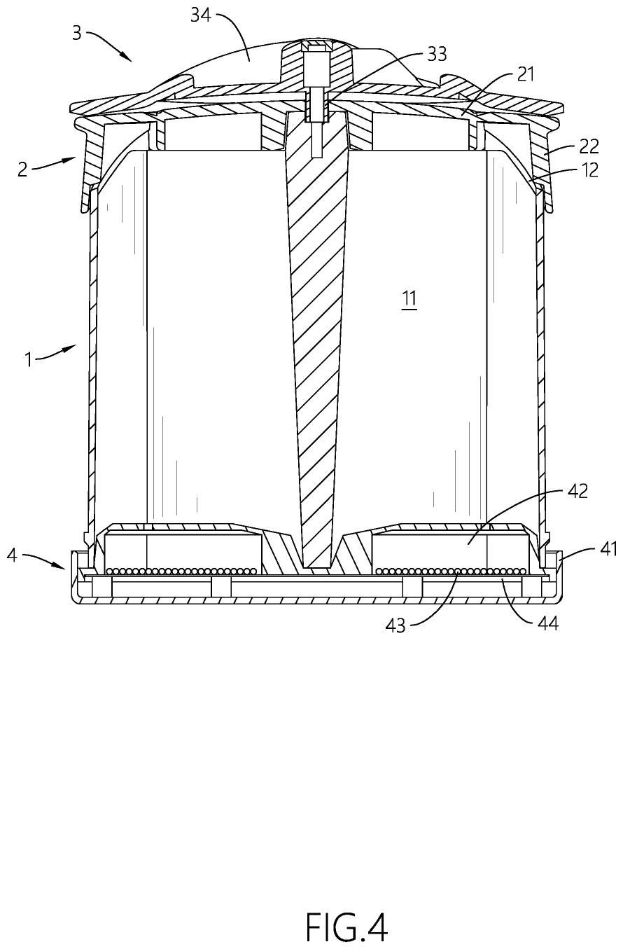

With reference to FIGS. 3 and 4, the base 4 has an outer protrusion 41 surrounding the base 4. In this embodiment, the outer protrusion 41 is an edge part of the base 4 which protrudes radially from an outer surface of the lateral wall of the main body 1. The outer protrusion 41 provides a fulcrum for the user to separate the base 4 from the main body 1.

With reference to FIGS. 4 and 7 to 9, the upper cover 3 has a pivot protrusion 33 formed on a bottom side of the upper cover 3, and the lower cover forms a pivot hole 23. The pivot protrusion 33 is disposed through the pivot hole 23, and thereby the upper cover 3 is rotatable with respect to the lower cover 2. To assemble the multi-compartment container, a bolt or a screw (not shown in the drawings) may be applied through the pivot hole 23 to fix the upper cover 3, the lower cover 2 and the main body 1 together, and thereby the pivot protrusion is rotatable in the pivot hole 23.

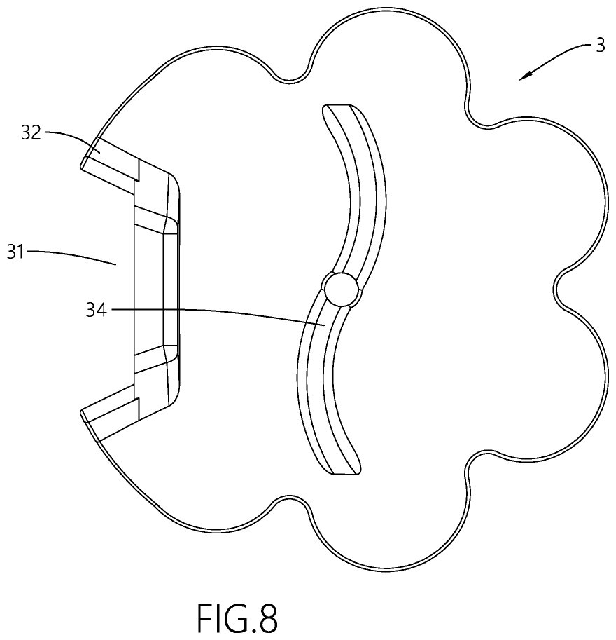

With reference to FIG. 8, the upper cover 3 may have a handle portion 34 mounted on a top of the upper cover 3, and thereby the user is able to rotate the upper cover 3.

With reference to FIGS. 4 and 6, the main body 1 has an anti-slip strip 13 mounted on the main body 1, and the anti-slip strip 13 contacts the base 4. To be more precise, when the base 4 and the main body 1 engage with each other, the anti-slip strip 13 is located between the main body 1 and the base 4, thereby preventing the base 4 separating from the main body 1.

With reference to FIGS. 2 and 4, the base 4 may further have a moisture proof portion 42, a desiccant 43, and a heating unit 44. The moisture proof portion 42 has an inner space fluidly communicating with the compartments 11 of the main body 1, and the desiccant 43 is disposed in the inner space.

To be more precise, in this embodiment, the base 4 has multiple moisture proof portions 42 protruding from a top surface of the base 4, and each one of the moisture proof portions 42 extends into a corresponding one of the compartments 11 of the main body 1. The top surface of the base 4 forms multiple holes such that the inner space of each one of the moisture proof portions 42 fluidly communicates with the corresponding compartment 11, but it is not limited thereto.

The heating unit 44 contacts the moisture proof portion 42. To be more precise, in this embodiment, the desiccant 43 is reusable after properly heated, and the heating unit 44 is an electro heater film located in the base 4 and contacts the moisture proof portion 42. In addition, the heating unit 44 is connected with a power socket 45, and thereby the user can connect a power cable to the heating unit 44 to generate heat, but it is not limited thereto. The configuration of the heating unit 44 may be altered according to need.

Besides, in this embodiment, the main body 1 and the upper cover 3 are made of food-grade polyethylene glycol terephthalate (PET), and the lower cover and the base 4 are made of food-grade silicone. Therefore, each of the main body 1, the upper cover 3, the lower cover 2, and the base 4 has the advantages of non-toxicity, high temperature resistance, impact resistance, etc., and therefore is safe in contact with the medications. In addition, made of silicone, the lower cover 2 and the base 4 have better softness to closely contact the main body 1, and thus improving sealing and moisture proof effects. However, it is not limited thereto, as materials of the main body 1, the upper cover 3, the lower cover 2, and the base 4 may be altered according to need.

Furthermore, as shown in FIGS. 1 and 5, each one of the compartments 11 may have a sign located on the lateral wall of the main body 1, such as a MAX line 112, to mark a maximum capacity of each one of the compartments 11. In addition, each one of the compartments 11 may have a labeling area located on the lateral wall of the main body 1, and thus the user can recognize the information of the drug in each one of the compartments 11, but it is not limited thereto.

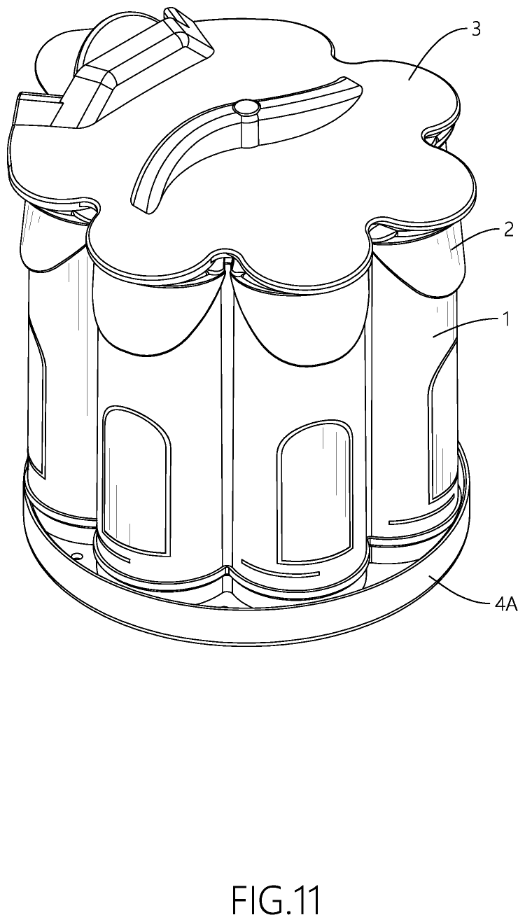

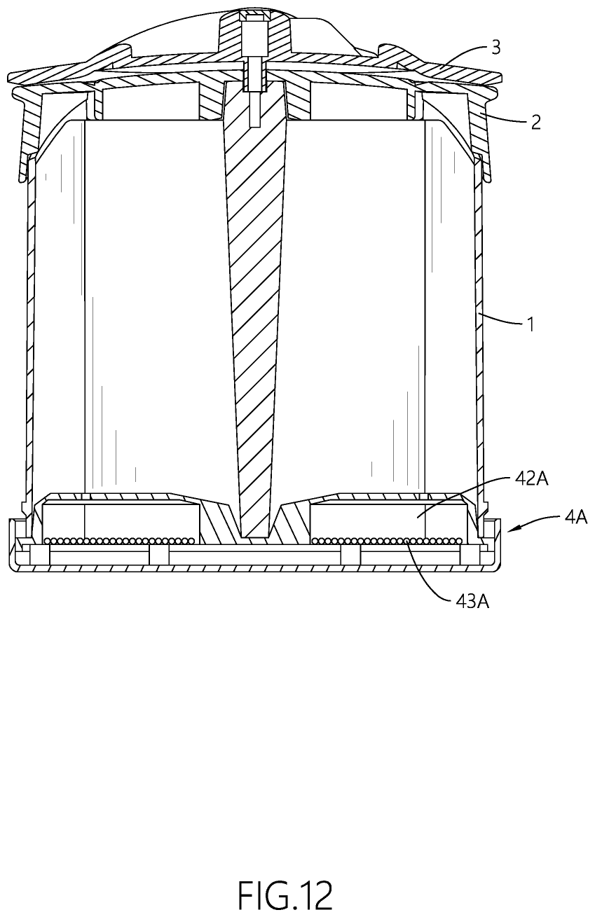

With reference to FIGS. 11 and 12, a second embodiment of the multi-compartment container is similar to the first embodiment, and the main difference of the second embodiment from the first embodiment is the base 4A. The base 4A in this embodiment lacks the heating unit. In addition, the desiccant 43A in the moisture proof portion 42A may be non-reusable, and the user may replace the desiccant 43A as long as the desiccant 43A reaches the limit of moisture absorption.

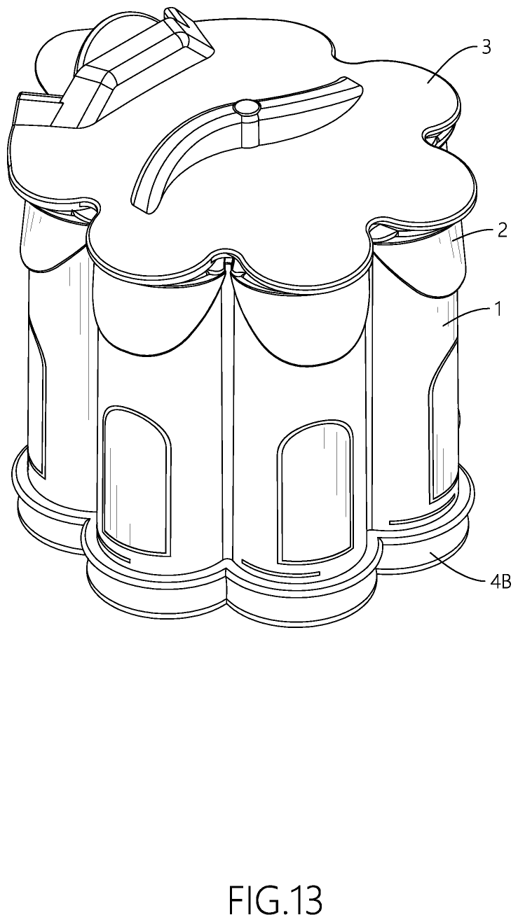

With reference to FIG. 13, a third embodiment of the multi-compartment container is similar to the first embodiment, and the main difference of the third embodiment from the first embodiment is that the base 4B in the third embodiment does not have the moisture proof portions, the desiccant, and the heating unit. In this embodiment, the base 4 fits the shape of the compartments 11, thus shaped like a flower.

The multi-compartment container has multiple said compartments 11, and thereby the user can store different types of medications without mixing them. The user can rotate the upper cover 3 with respect to the lower cover 2 to turn the flipping notch 31 to a particular compartment 11, thereby flipping up the corresponding flip cover 22, and then the user can take out the medications in the compartment 11. Moreover, the multi-compartment container may further have the desiccant 43 in the moisture proof portion 42 to absorb the moisture in the compartments 11 to keep dry, and thus the storage period of the medications in the compartments 11 may be prolonged.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A multi-compartment container comprising:
a main body having multiple compartments, the compartments symmetrically surrounding a central axis of the main body;
a base mounted at a bottom side of the main body;
a lower cover mounted on a top of the main body, the lower cover having a central board and multiple flip covers, and the flip covers disposed along edges of the central board; a location of each one of the flip covers corresponding to a respective one of the compartments of the main body;
an upper cover rotatably mounted on a top of the lower cover; the upper cover having a flipping notch, the flipping notch selectively aligned with one of the flip covers, thereby flipping up said one of the flip covers.

2. The multi-compartment container as claimed in claim 1, wherein:
each one of the flip covers has an elastic unit mounted on an inner side of the flip cover.

3. The multi-compartment container as claimed in claim 2, wherein the upper cover has:
two oblique boards located on two opposite sides of the flipping notch, and each one of the two oblique boards inclined inward and upward with respect to the flipping notch.

4. The multi-compartment container as claimed in claim 1, wherein:
the main body forms multiple lateral notches, each one of the lateral notches is located at a lateral wall of a corresponding one of the compartments, and each one of the lateral notches is adjacent to the lower cover; and
each one of the flip covers covers a corresponding one of the lateral notches.

5. The multi-compartment container as claimed in claim 3, wherein:
the main body forms multiple lateral notches, each one of the lateral notches is located at a lateral wall of a corresponding one of the compartments, and each one of the lateral notches is adjacent to the lower cover; and
each one of the flip covers covers a corresponding one of the lateral notches.

6. The multi-compartment container as claimed in claim 1, wherein:
the main body has:
multiple partition walls, each one of the partition walls located between adjacent two of the compartments;
the lower cover has:
multiple support frames mounted at a bottom side of the central board, the support frames surrounding a central axis of the lower cover and disposed symmetrically with respect to said central axis; and
each one of the partition walls engages with a corresponding one of the support frames.

7. The multi-compartment container as claimed in claim 5, wherein:
the main body has:
multiple partition walls, each one of the partition walls located between adjacent two of the compartments;
the lower cover has:
multiple support frames mounted at a bottom side of the central board, the support frames surrounding a central axis of the lower cover and disposed symmetrically with respect to said central axis; and
each one of the partition walls engages with a corresponding one of the support frames.

8. The multi-compartment container as claimed in claim 1, wherein the base has:
an outer protrusion surrounding the base.

9. The multi-compartment container as claimed in claim 7, wherein the base has:
an outer protrusion surrounding the base.

10. The multi-compartment container as claimed in claim 1, wherein:
the upper cover has a pivot protrusion formed on a bottom side of the upper cover, and the lower cover forms a pivot hole; and
the pivot protrusion is disposed through the pivot hole.

11. The multi-compartment container as claimed in claim 9, wherein:
the upper cover has a pivot protrusion formed on a bottom side of the upper cover, and the lower cover forms a pivot hole; and
the pivot protrusion is disposed through the pivot hole.

12. The multi-compartment container as claimed in claim 1, wherein the main body has:
an anti-slip strip mounted on the main body and contacting the base.

13. The multi-compartment container as claimed in claim 11, wherein the main body has:
an anti-slip strip mounted on the main body and contacting the base.

14. The multi-compartment container as claimed in claim 1, wherein the base has:
a moisture proof portion having an inner space fluidly communicating with the compartments of the main body; and
a desiccant disposed in the inner space.

15. The multi-compartment container as claimed in claim 13, wherein the base has:
a moisture proof portion having an inner space fluidly communicating with the compartments of the main body; and
a desiccant disposed in the inner space.

16. The multi-compartment container as claimed in claim 14, wherein the base has:
a heating unit contacting the moisture proof portion.

17. The multi-compartment container as claimed in claim 15, wherein the base has:
a heating unit contacting the moisture proof portion.

18. The multi-compartment container as claimed in claim 14, wherein the moisture proof portion protrudes from a top surface of the base and extends into the compartments of the main body.

19. The multi-compartment container as claimed in claim 17, wherein the moisture proof portion protrudes from a top surface of the base and extends into the compartments of the main body.
